(19) United States
(12) Patent Application Publication
(10) Pub. No.: US 2009/0026782 A1
(43) Pub. Date: Jan. 29, 2009

(54) DUAL USE CHOPSTICK AND CHOPSTICK ASSEMBLY FOR GRASPING SOLID FOODS AND DRINKING LIQUIDS

(76) Inventor: Norman J. Lion, New York, NY (US)

Correspondence Address: STANLEY H. KREMEN, 4 LENAPE LANE, EAST BRUNSWICK, NJ, 08816, US

(21) Appl. No.: 12/235,758

(22) Filed: Sep. 23, 2008

(51) Int. Cl. A47G 21/06; B25B 9/00

(52) U.S. Cl. 294/99.2; 294/141

(57) ABSTRACT

The Present Invention is for a chopstick that is hollow along its longitudinal axis. As such, it is a drinking straw that is constructed from a material sturdier than conventional drinking straws. As such, it has a top and a bottom end. The top end is used for holding and sipping. The bottom end is used to hold food and is immersed in liquid. An undesired effect of the dual use is that solid food could possible travel up the chopstick straw and become lodged therein. So, to prevent this from happening, a thin wire barrier is positioned across the bottom end. The wire barrier is used to deflect solid food from entering the solid straw along with the liquid.

### FIELD OF THE INVENTION

The Present Invention relates to the field of eating and drinking utensils.

### BACKGROUND OF THE INVENTION

Chopsticks have been used for centuries in Asian countries as utensils for eating food. During the past several decades, American diners began using chopsticks in restaurants that serve Asian food. Many of these diners prefer using chopsticks over using forks. However, outside of the Asian restaurants, they continue to use forks and knives. So, chopsticks are used mainly as a novelty by Americans. Even though they use chopsticks in these restaurants, they continue to use forks, spoons, and drinking straws.

Since chopsticks are primarily a novelty item, it would be useful to enhance their novelty. Many American patrons of Asian restaurants would like to use chopsticks not only for grasping solid foods but also as a drinking straw for liquids. In addition, many American patrons, especially children, find chopsticks difficult to use. It would be desirable to have a chopstick assembly that would make it easier to grasp food as well as to be used for drinking liquids.

### SUMMARY OF THE INVENTION

The Present Invention is for a chopstick that is hollow along its longitudinal axis. As such, it is a drinking straw that is constructed from a material sturdier than conventional drinking straws. As such, it has a top and a bottom end. The top end is used for holding and sipping. The bottom end is used to hold food and is immersed in liquid. An undesired effect of the dual use is that solid food could possible travel up the chopstick straw and become lodged therein. So, to prevent this from happening, a thin wire barrier is positioned across the bottom end. The wire barrier is used to deflect solid food from entering the solid straw along with the liquid.

### BRIEF DESCRIPTION OF THE DRAWINGS

FIG. 1 shows a conventional pair of chopsticks joined together along their common longitudinal axis. These chopsticks are prior art.

FIG. 1(a) is a top plan view of the pair of joined chopsticks.

FIG. 1(b) is a front elevational view of the pair of joined chopsticks.

FIG. 2 shows a conventional pair of chopsticks grasping food (e.g., a grain of rice).

FIG. 3 shows views of the top and bottom ends of a first embodiment of the Present Invention.

FIG. 3(a) is a top plan view of the top end of the chopstick straw.

FIG. 3(b) is a front elevational view of the top end of the chopstick straw.

FIG. 3(c) is a front elevational view of the bottom end of the chopstick straw.

FIG. 3(d) is a bottom plan view of the bottom end of the chopstick straw.

FIG. 4 is a top plan view showing a second embodiment of the assembly of a single chopstick straw.

FIG. 4(a) shows the assembled embodiment.

FIG. 4(b) is an exploded view of the embodiment.

FIG. 5 shows views of the top and bottom ends of the second embodiment of the Present Invention.

FIG. 5(a) is a top plan view of the top end of the chopstick straw.

FIG. 5(b) is a front elevational view of the top end of the chopstick straw.

FIG. 5(c) is a front elevational view of the bottom end of the chopstick straw.

FIG. 5(d) is a bottom plan view of the bottom end of the chopstick straw.

FIG. 6 shows a single chopstick straw immersed in liquid.

FIG. 7 shows two chopstick straws immersed in liquid.

FIG. 8 is a cross sectional view of a third embodiment of the Present Invention comprising two chopstick straws that may be easily grasped for use with solid food and can also be used for drinking liquids.

FIG. 9 is a front elevational view of the third embodiment.

FIG. 10 is an isometric view of the third embodiment immersed in a liquid.

### DETAILED DESCRIPTION OF THE INVENTION

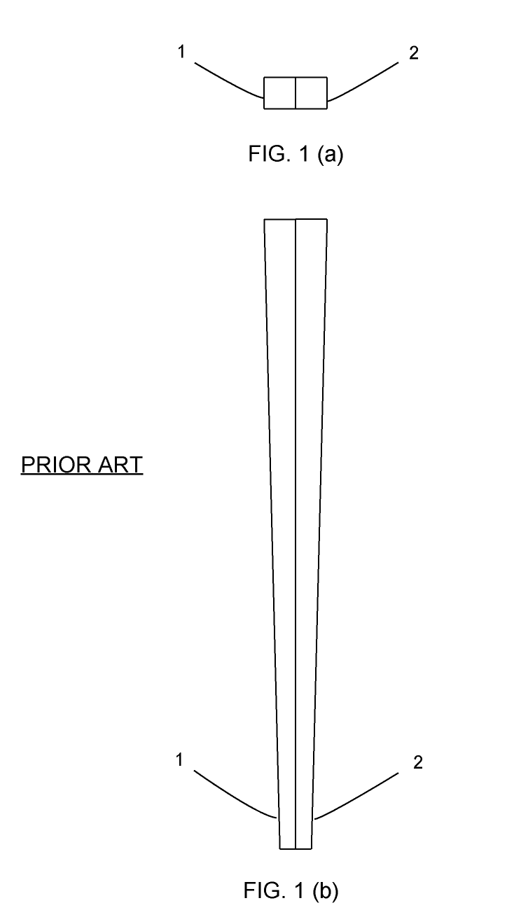

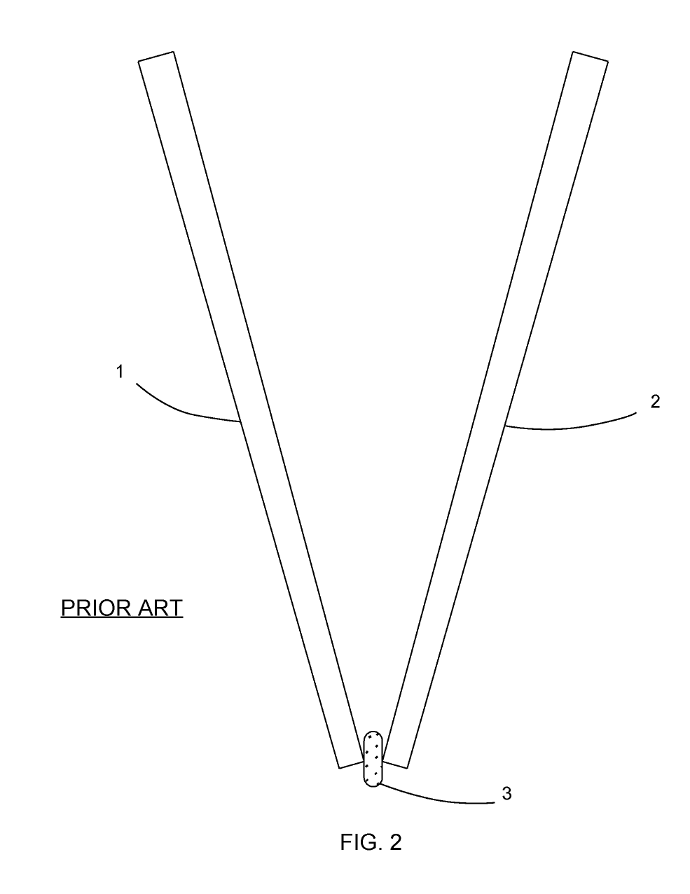

Commercially, chopsticks are manufactured in a finite number of forms. The most common are those distributed to patrons in Chinese and Japanese restaurants. Chinese restaurants typically carry and distribute to customers thick plastic chopsticks, each one of which comprises a top end rectangular prism and a bottom end cylinder. Japanese restaurants typically carry and distribute to customers thinner wooden chopsticks. These chopsticks normally fused as a single piece of wood (or wooden unit) which is scored on the longitudinal axis. This type of chopstick unit is shown in FIG. 1. The customer breaks the wooden unit into two chopsticks numbered 1 and 2 in the figure. Once separated, the two chopsticks 1 and 2 are used to grasp food 3 as shown in FIG. 2.

The Present Invention is applicable to any type of chopstick. However, in the figures, only the Japanese restaurant type chopsticks are illustrated. Yet, the Present Invention is not limited to this type of chopstick.

At first glance, the chopstick straw of the Present Invention looks like a conventional chopstick. There are two differences. First, the chopstick is hollow along its longitudinal axis just like a straw, except that the chopstick is sturdier. The sturdiness and rigidity is necessary to facilitate grasping food. Were this the only difference, there would be a problem where small food particles could stick to the bottom of the chopstick only to be sucked in during the drinking process. These food particles could become lodged in the chopstick. To prevent this, a small wire is attached to the bottom of the chopstick so as to dissect the bottom opening. Of course, more than one wire can be used.

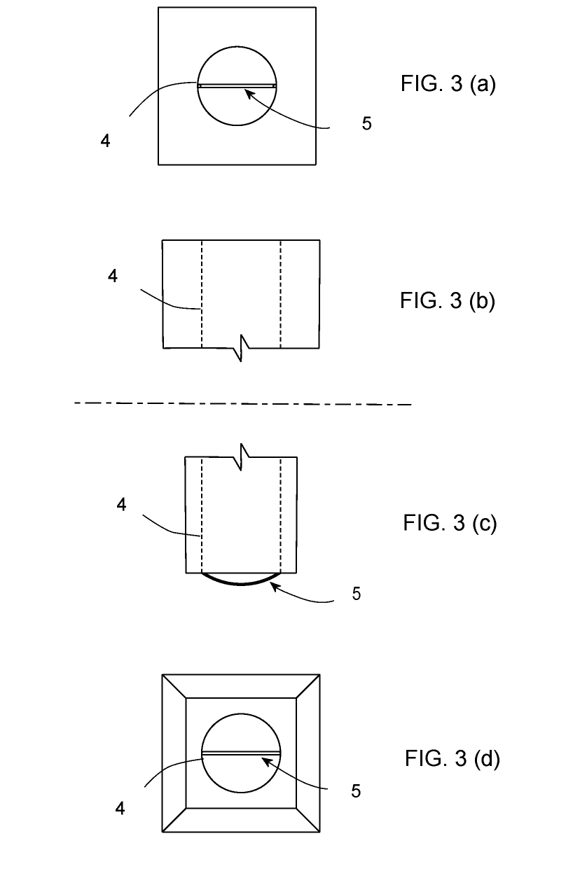

A first embodiment of the Present Invention is shown in FIG. 3. In this embodiment, the chopstick is made hollow by splitting the chopstick in half along the longitudinal axis, scoring the wood to create a channel, and rejoining the two halves. FIG. 3(a) and FIG. 3(b) show the top end of the chopstick straw while FIG. 3(c) and FIG. 3(d) show the bottom end of the chopstick. FIG. 3(c) is a front elevational view of the bottom end of the chopstick straw of the first embodiment. Shown with hidden lines, element 4 is the wall of the hollow passageway that extends through the chopstick. Element 5 is the wire attached to the bottom end of the chopstick. FIG. 3(d) is a bottom plan view of the bottom end of the first embodiment. FIG. 3(a) is a top plan view of the chopstick straw of the first embodiment. In FIG. 3(b), wall 4 is shown by hidden lines. In FIG. 3(a), a viewer can look through the hole to see wire 5 on the bottom of the chopstick.

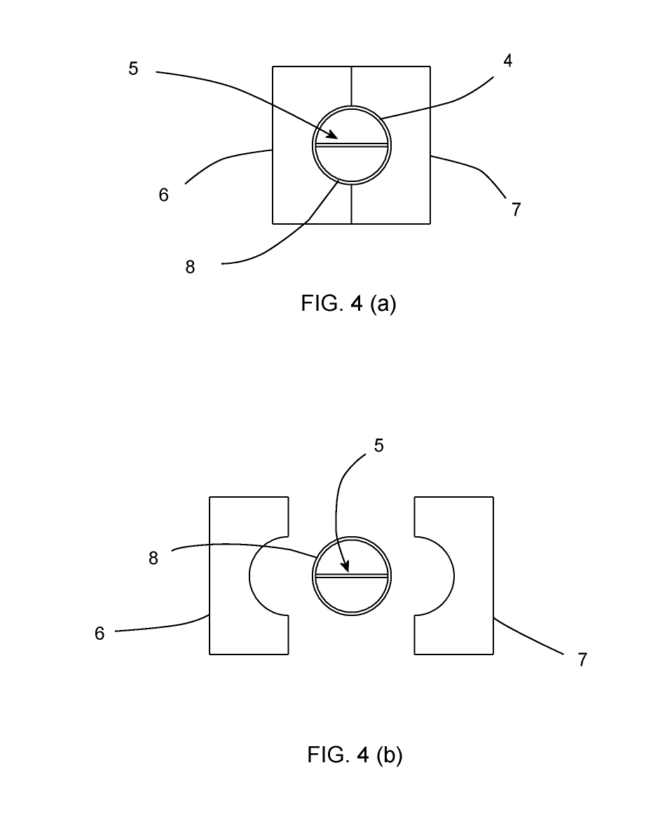

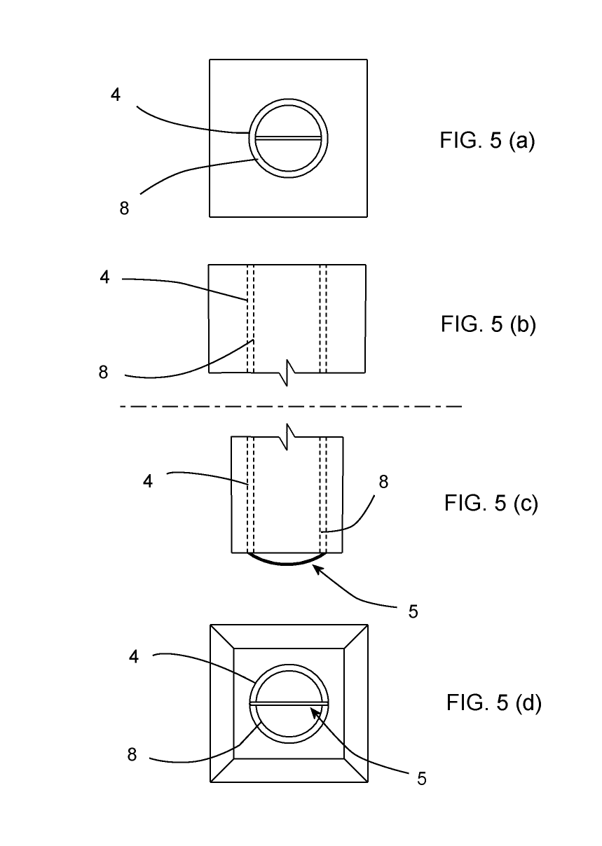

A second embodiment is shown in FIG. 4. Here, as in the first embodiment, the chopstick is split along the longitudinal axis and scored into a groove. Then a hollow tube or straw is placed into the groove, and the two halves of the chopstick are joined into one. FIG. 4(a) is a top plan view of this chopstick. Hollow tube 8 is placed into the groove defined by 4. Wire 5 is attached directly to the bottom of hollow tube 8. FIG. 4(b) is an exploded view of the chopstick prior to assembly. Elements 6 and 7 represent the two halves of a single chopstick. When 6 and 7 are joined together, the chopstick of FIG. 4(a) is produced. FIG. 5 shows the top and bottom ends of the chopstick straw of the second embodiment. FIG. 4(a) is a top plan view of the top end; FIG. 4(b) is a front elevational view of the top end; FIG. 4(c) is a front elevational view of the bottom end; and FIG. 4(d) is a bottom plan view of the bottom end.

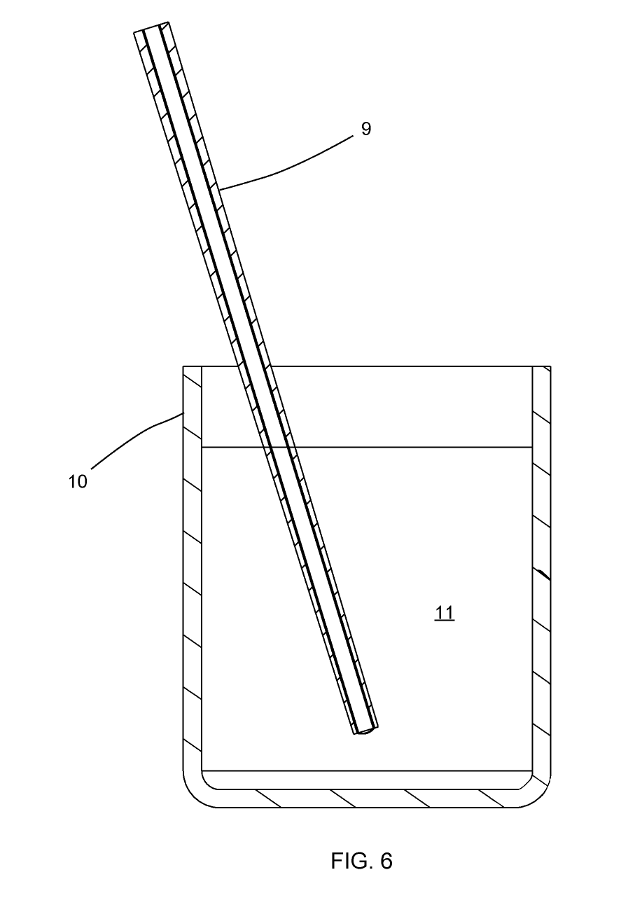

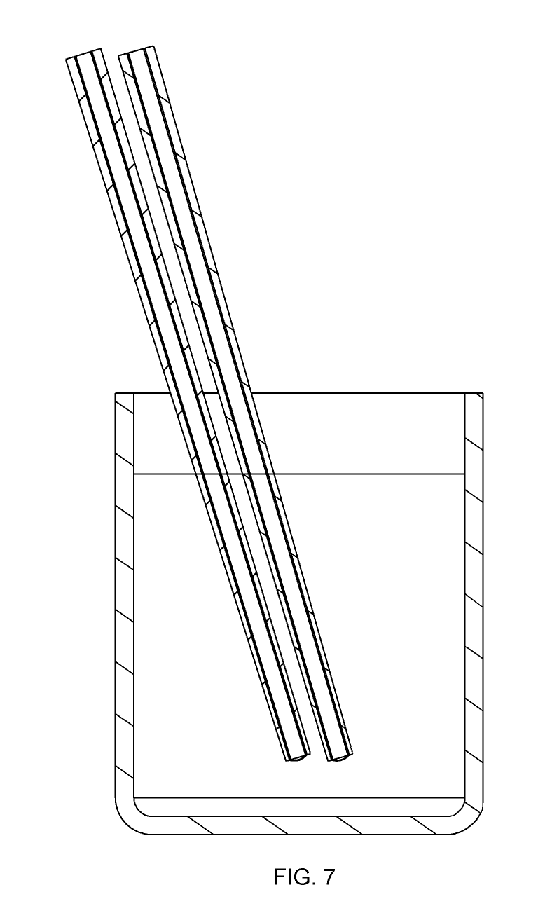

FIG. 6 shows the chopstick straw of the Present Invention immersed in liquid 11 contained in drinking glass or cup 10. Sometimes people drink liquids with a single straw, while others drink through two straws. FIG. 7 shows two chopstick straws immersed in liquid.

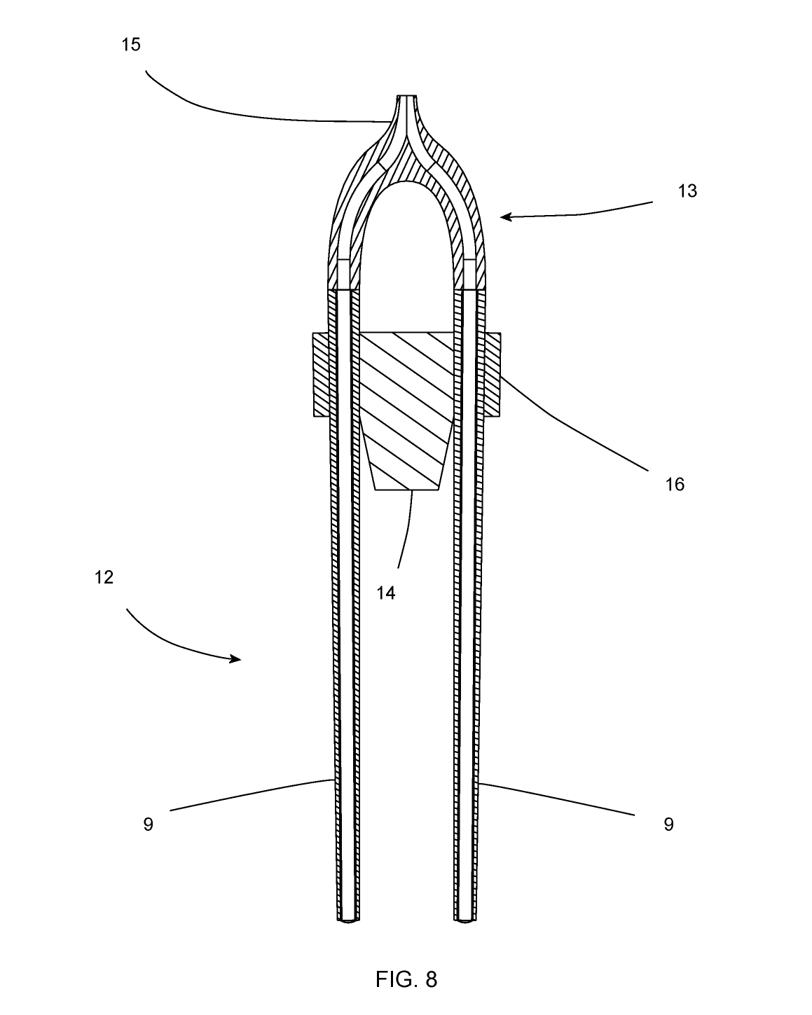

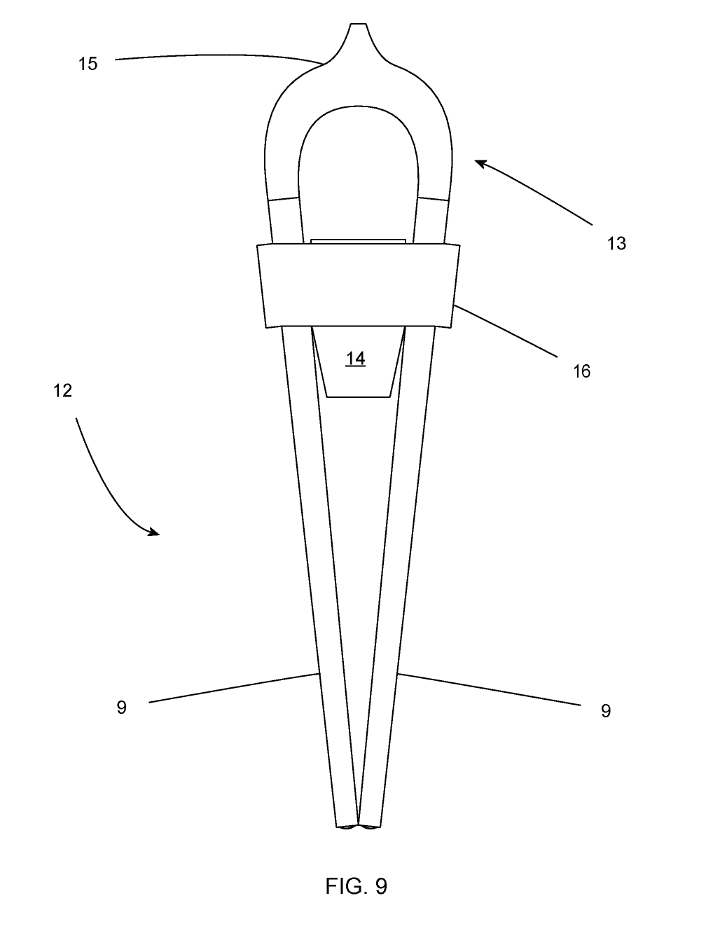

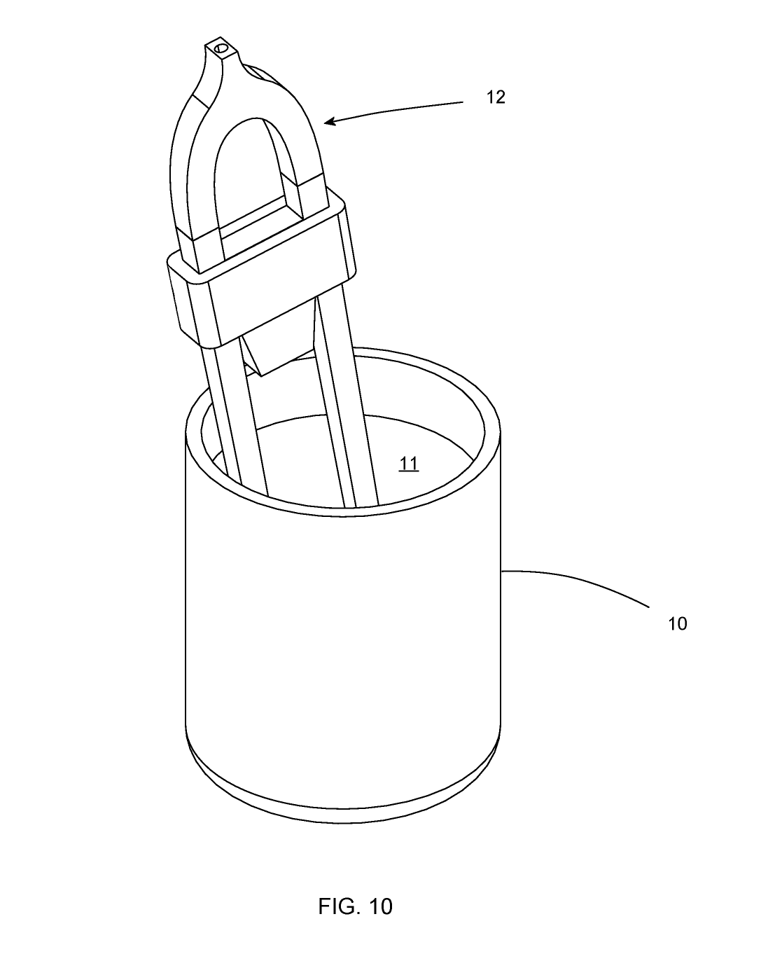

FIGS. 8-10 illustrate a third embodiment of the invention. Asian nationals are trained in the use of chopsticks while children. While many Americans are proficient in the use of chopsticks, many others do not have this proficiency. Yet, because of the novelty, those who are unable to grasp food with chopsticks want to use them nonetheless. FIG. 8 is a cross sectional view of the third embodiment of the Present Invention. This embodiment 12 comprises two chopstick straws 9 described previously being held together by elastic band 16 which presses them against block 14. Attached to the top of each chopstick straw is a hollow “Y” junction 13 (shown as an upside-down “Y” in the drawing). The “Y” junction 13 terminates in a drinking end 15 which comprises a single hole for liquid to pass. FIG. 9 is a front elevational view of the third embodiment 12. Here, chopstick straws 9 have been pressed together at their bottom ends. The chopsticks may now grasp food. The top ends still remain attached to block 14, but the elastic band 16 stretches. FIG. 10 shows the third embodiment of the present invention immersed in liquid 11 in vessel 10 so that a person can drink the liquid.

1. A manufactured article comprising:
a) at least one chopstick having a longitudinal axis, a top end, a bottom end, an exterior surface, and an interior volume, wherein said at least one chopstick further comprises a hollow channel running along the entire longitudinal axis within the interior volume thereby forming a top opening and an opposite bottom opening, such that liquid may flow through the channel from the bottom opening to the top opening, and vice versa; and
b) a thin wire barrier securely fastened to the bottom end of the at least one chopstick, wherein said wire barrier is positioned so as to essentially prevent solid particles from entering the channel.

2. The manufactured article of claim 1 wherein the channel is cylindrical.

3. The manufactured article of claim 1 wherein the number of chopsticks is two.

4. The manufactured article of claim 1 further comprising a hollow tube that is placed within the channel such that liquid may flow through the hollow tube from the bottom opening to the top opening, and vice versa.

5. The manufactured article of claim 3 further comprising:
a) a hollow “Y” shaped fixture having first and second ends, with the first end further comprising two openings and the second end further comprising only one opening, wherein the top end of each of the two chopsticks is inserted into each of the two openings of the first end of the “Y” shaped fixture;
b) a block; and
c) an elastic band that holds the top ends of both chopsticks against the block;
wherein:
i) the two chopsticks are normally in a position parallel to each other;
ii) the two chopsticks are squeezed together at their bottom ends for grasping food;
iii) when the two chopsticks are no longer squeezed together, they return to their normally parallel position; and
iv) liquid may pass through each of the two chopsticks from the bottom end to the top end, and then through the “Y” shaped fixture to the single opening at the second end of the “Y” shaped fixture.

6. A method of manufacturing the manufactured article of claim 1 comprising:
a) splitting the at least one chopstick along its longitudinal axis to form two halves;
b) grooving the channel along the entire longitudinal axis of each half such that were the two halves to be rejoined, a single channel would be formed; and
c) rejoining the two halves and bonding them together.

7. The method of claim 6 further comprising placing a hollow tube into the grooved channel in one of the two halves prior to rejoining such that when the two halves are rejoined, the hollow tube lies completely within the channel.
